(19) United States
(12) Patent Application Publication
(10) Pub. No.: US 2010/0221549 A1
(43) Pub. Date: Sep. 2, 2010

(54) ELECTRICAL STEEL SHEET HAVING INSULATION COATING AND METHOD FOR MANUFACTURING SAME

(75) Inventors: Tomofumi Shigekuni, Tokyo (JP); Kazumichi Sashi, Tokyo (JP); Masaaki Kohno, Tokyo (JP); Yuka Komori, Tokyo (JP)

Correspondence Address: IP GROUP OF DLA PIPER LLP (US), ONE LIBERTY PLACE, 1650 MARKET ST, SUITE 4900, PHILADELPHIA, PA, 19103, US

(73) Assignee: JFE Steel Corporation,, Chiyoda-ku, Tokyo (JP)

(21) Appl. No.: 12/159,270

(22) PCT Filed: Dec. 26, 2006
(86) PCT No.: PCT/JP2006/326340

§ 371 Date: Jun. 26, 2008

(30) Foreign Application Priority Data
Dec. 28, 2005 (JP) 2005-377067
Dec. 8, 2006 (JP) 2006-331788

(51) Int. Cl. B32B 15/08; B05D 3/02; B32B 15/082; B32B 15/088; B32B 15/09; B32B 15/092; B32B 15/095

(52) U.S. Cl. 428/412; 428/447; 428/425.8; 428/418; 427/387

(57) ABSTRACT

An insulation coating containing a composite resin composed of polysiloxane and a polymer containing carbon is formed on the surface of an electrical steel sheet, thus obtaining an electrical steel sheet having an insulation coating that gives corrosion resistance and punchability equivalent to or higher than those of Cr-containing insulation coating.

### RELATED APPLICATIONS

This is a §371 of International Application PCT/JP2006/326340, with an international filing date of Dec. 26, 2006 (WO 2007/074927 A1, published Jul. 5, 2007), which is based on Japanese Patent Application Nos. 2005-377067, filed Dec. 28, 2005, and 2006-331788, filed Dec. 8, 2006.

### TECHNICAL HELD

This disclosure relates to electrical steel sheets having an insulation coating and to methods for manufacturing thereof, and specifically relates to electrical steel sheets having an insulation coating which substantially does not contain chromium, and to methods for manufacturing thereof.

### BACKGROUND

Insulation coating on an electrical steel sheet used for motors, transformers, and the like is requested to have not only interlaminar resistance but also varieties of characteristics such as convenience during working and forming and stability during storage and use. Furthermore, since electrical steel sheets are used in varieties of applications, there are developed various kinds of insulation coating responding to each application.

For example, when an electrical steel sheet is treated by punching, shearing, bending, and the like, the residual strain deteriorates the magnetic characteristics. To recover the deteriorated magnetic characteristics, stress relieving annealing is often applied to thus treated electrical steel sheet at an approximate temperature range from 750° C. to 850° C. On applying the stress relieving annealing, the insulation coating has to endure the annealing treatment.

The insulation coating is roughly grouped into three kinds: (a) inorganic coating which emphasizes weldability and heat resistance, and endures the stress relieving annealing (excluding organic resin, in principle); (b) semi-organic coating comprising an inorganic compound as the basis and containing an organic resin, which aims to have both punchability and weldability, and endures the stress relieving annealing; and (c) organic coating for special applications, which cannot be treated by stress relieving annealing. As of these, the ones for general use, which endure the stress relieving annealing, are (a) and (b) which are the coatings containing inorganic compound, both of which contain chromium compound in the coating. Particularly, the chromate-based insulation coating of (b) type, containing organic resin, is widely used owing to the considerable improvement of punchability compared with the inorganic-based insulation coating.

For example, Examined Japanese Patent Publication No. 60-36476 describes an electrical steel sheet having an electrical insulation coating, which is manufactured by applying a coating liquid on the surface of a steel sheet, followed by baking by a known method, which coating liquid is prepared by mixing a bichromate-based aqueous solution containing at least one kind of bivalent metal with 5 to 120 parts by weight of solid content of a resin emulsion (vinyl acetate and Veo Va (TM) at a ratio ranging from 90/10 to 40/60), and 10 to 60 parts by weight of an organic reducing agent, to 100 parts by weight of CrO₃ in the aqueous solution.

Most of that type of chromate-based coatings for electric steel sheet contains trivalent chromium as the steel sheet products, raising no toxicity problem. Since, however, toxic hexavalent chromium has to be used in the stage of coating liquid, there is required to observe strict handling regulations as well as establishing satisfactory apparatus to secure good workplace environment.

Under the present state and responding to the recent increasing concern about the environment, also the field of electrical steel sheet faces the request of customers to supply products having insulation coating free from chromium.

As the technology using a main component other than chromic acid, many kinds of semi-organic insulation coatings containing inorganic colloid such as silica as the main component are disclosed. Owing to unnecessariness of handling toxic hexavalent chromium solution, those semi-organic insulation coatings containing inorganic colloid as the main component are highly advantageously used in view of environment. For instance, Japanese Patent Laid-Open No. 10-34812 discloses a method to improve the corrosion resistance of inorganic colloids by regulating the quantity of Cl and S in the resin/silica coating to a specified level or below. The method improves the corrosion resistance of the product sheet in a humidity cabinet test environment. However, the corrosion resistance thereof under severe conditions such as salt spray cannot reach the level of the corrosion resistance of the case applying Cr-containing insulation coating. Furthermore, with the addition of silica, punchability also cannot reach the good level of the case applying Cr-containing insulation coating, as in the case of corrosion resistance.

It could therefore be advantageous to provide electrical steel sheets having an insulation coating which has performance equivalent to or higher than that of Cr-containing insulation coating even as an insulation coating containing an inorganic compound free from Cr as the main component, giving excellent corrosion resistance and punchability, and to provide a method for manufacturing thereof.

### SUMMARY

The corrosion resistance of product sheets with silica-based chromate-free coating cannot fully be improved even by decreasing the amount of impurities such as Cl and SO₄²⁻, and the corrosion resistance thereof becomes nonuniform depending on the manufacturing conditions.

We confirmed in many cases that deterioration in corrosion resistance is accompanied by cracks in the coating. That is, since colloidal silica does not allow the silica to form a three-dimensional network (network structure) at a baking temperature ranging from about 200° C. to about 300° C., thus the silica itself has no film-formability, which is presumably the cause of crack generation in the coating and of nonuniformily of corrosion resistance depending on the manufacturing conditions.

From the above, we found that formation of a three-dimensional network of —Si—O— is important to form a coating having good corrosion resistance and that providing the resin with a polysiloxane structure therein, and by crosslinking the polysiloxane with organic matter, surprising results may be achieved.

We thus provide:
(1) An electrical steel sheet having an insulation coating, wherein the insulation coating contains a composite resin composed of polysiloxane and a polymer containing carbon.
(2) The electrical steel sheet having the insulation coating according to (1), wherein the blending ratio of the polysiloxane to the solid content in the insulation coating is 10% by mass or more and 90% by mass or less as SiO₂.
(3). The electrical steel sheet having the insulation coating according to (1) or (2), wherein the polymer containing carbon is one or more polymers selected from the group consisting of vinyl-based polymer, polyester-based polymer, alkyd-based polymer, poly-urethane-based polymer, acrylic-based polymer, styrene-based polymer, polyethylene-based polymer, polypropylene-based polymer, polyamide-based polymer, polycarbonate-based polymer, phenol-based polymer, and epoxy-based polymer.
(4) The electrical steel sheet having the insulation coating according to any of (1) to (3), wherein the insulation coating further contains one or more compounds selected from the group consisting of silica, silicate, alumina, titania, tin oxide, cerium oxide, antimony oxide, tungsten oxide, and molybdenum oxide, as the inorganic compound.
(5) The electrical steel sheet having the insulation coating according to any of (1) to (4), wherein the coating weight of the insulation coating is 0.05 g/m² or more and 10 g/m² or less.
(6) A method for manufacturing an electrical steel sheet having an insulation coating, having the steps of: applying a coating liquid containing polysiloxane and a polymer containing carbon element on the surface of an electrical steel sheet; and baking the electrical steel sheet with the coating liquid applied on the electrical steel sheet.
(7) The method for manufacturing the electrical steel sheet having the insulation coating according to (6), wherein the polymer containing carbon uses one or more polymers selected from the group consisting of vinyl-based polymer, polyester-based polymer, alkyd-based polymer, polyurethane-based polymer, acrylic-based polymer, styrene-based polymer, polyethylene-based polymer, polypropylene-based polymer, polyamide-based polymer, polycarbonate-based polymer, phenol-based polymer, and epoxy-based polymer.
(8) The method for manufacturing the electrical steel sheet having the insulation coating according to (6) or (7), wherein the coating liquid further contains one or more compounds selected from the group consisting of silica, silicate, alumina, titania, tin oxide, cerium oxide, antimony oxide, tungsten oxide, and molybdenum oxide, as the inorganic compound.
(9) The method for manufacturing the electrical steel sheet having the insulation coating according to any of (6) to (8), wherein the blending ratio of the polysiloxane to the total solid content in the coating liquid is 10% by mass or more and 90% by mass or less as SiO₂.
(10) The method for manufacturing electrical steel sheet having the insulation coating according to any of (6) to (9), wherein the coating liquid is applied and baked on the surface of the electrical steel sheet so as the coating weight of the insulation coating to become 0.05 g/m² or more and 10 g/m² or less.

### DETAILED DESCRIPTION

Our electrical steel sheets are steel sheets having an insulation coating. The insulation coating contains a composite resin composed of polysiloxane and a polymer containing carbon. The chemical composition is important. With that insulation coating, there are provided corrosion resistance and punchability equivalent to of higher than those of the electrical steel sheet having a Cr-containing insulation coating.

### Electrical Steel Sheet

The description begins with an electrical steel sheet.

The electrical steel sheet (also referred to “electrical iron sheet”) before forming the coating, which can be used, may be the one having any composition, not specifically limited, if only it is a steel sheet (iron sheet) which is adjusted to have at least the specific resistivity to obtain the desired magnetic characteristics (such as low iron loss). Specifically preferred is to apply to medium to high grade electrical steel sheets containing sole Si or (Si+Al) in a range from about 0.1 to about 10.0% by mass, and giving about W_{15/50}≦5.0 W/kg.

The surface of the electrical steel sheet oh which the insulation coating is to be formed may be subjected to arbitrary preliminary treatment such as degreasing by alkali or the like, pickling by hydrochloric acid, sulfuric acid, phosphoric acid, and the like, intensifying, and magnetic domain refining, and may be as-manufactured surface (untreated).

Although forming a third layer between the insulation coating and the steel sheet surface is not necessarily required, the third layer may be formed as needed. For example, ordinary manufacturing methods may form an oxide film of the metal of steel sheet between the insulation coating and the steel sheet surface. The step of removing the oxide film can be eliminated. Although a forsterite film may be formed depending on the manufacturing method, the step of removing the film can be eliminated.

### Insulation Coating

Next is the description about the insulation coating applied on the surface of the above-steel sheet.

The insulation coating is obtained by applying a coating liquid containing polysiloxane and a polymer containing carbon, which are essential components described below, on the surface of the electrical steel sheet, followed by baking.

### Polysiloxane

Polysiloxane is a polymer which has —Si—O— (siloxane bond) in the main molecular chain. The polysiloxane is preferably cross-linked with a polymer containing carbon via —C—Si—O— bond and/or —C—O—Si—O— bond, in advance. The term “cross-link” referred to herein signifies the formation of what is called the “hybrid structure” through geometrical or chemical bond or the like. By the cross-linking, the inorganic component and the organic component form a three-dimensional structure in advance. Accordingly, a homogeneous coating free from cracks can be stably formed, thus a coating having good corrosion resistance can be formed.

When the polysiloxane is further provided with a functional group such as hydroxyl group and alkoxy group, it is possible to further bond to a polymer portion having carbon, thus to strengthen the three-dimensional network.

The blending ratio of polysiloxane to the total solid content in the insulation coating (or the total coating amount after baking) is preferably adjusted to a range of 10% by mass or more and 90% by mass or less as SiO₂ (i.e. in terms of SiO₂). If the blending ratio thereof is less than 10% by mass, the percentage of remaining coating after stress relieving annealing becomes small so that the anti-sticking property deteriorates in some cases. When the blending ratio of polysiloxane increases, the coating becomes strong. If, however, the blending ratio thereof exceeds 90% by mass, the flexibility becomes insufficient, and the corrosion resistance may deteriorate depending on the manufacturing conditions. The blending ratio of polysiloxane to the total coating amount after the stress relieving annealing significantly increases owing to the decomposition of organic component (to 50% or more). Thus, the blending ratio thereof after the stress relieving annealing need not stay within the above preferable range.

On determining the amount of polysiloxane, the term “as SiO₂” means that the content of SiO₂ is calculated on the assumption that all the contained Si forms SiO₂. For example, when sole Si amount is measured, the amount is converted into the amount of “SiO₂,” and the ratio of the converted amount to the total solid content in the coating is determined.

The degree of polymerization of the polysiloxane is in an arbitrary range for applying without raising problem if only the degree provides the coating liquid. The degree of polymerization thereof is preferably adjusted to 10 or more as average.

### Polymer Containing Carbon

As the polymer containing carbon, varieties of polymers are applicable. Examples of applicable polymer are vinyl-abased polymer, polyester-based polymer, alkyd-based polymer, polyurethane-based polymer, acrylic-based polymer, polystyrene-based polymer, polyethylene-based polymer, polypropylene-based polymer, polyamide-based polymer, polycarbonate-based polymer, phenol-based polymer, and epoxy-based polymer. It is preferable to contain one or more of above-given polymers. These polymers can be used as a copolymer of them.

As of these, it is further preferable that the polymer has a functional group capable of bonding at side chain of the polymer molecule from the viewpoint of forming a cross-link with polysiloxane via —C—Si—O— bonds and/or —C—O—Si—O— bonds, thus forming a three-dimensional network. Although the degree of polymerization is not specifically limited, raising no problem of application, if only it is in a range allowing forming the coating liquid, the degree is preferably 2 or more as average, and more preferably 5 or more as average.

The blending ratio of the polymer containing carbon to the total solid content in the insulation coating is preferably adjusted to 0.1 times or more the blending ratio of polysiloxane (above-described SiO₂ converted value).

Adding to the above components, the following-given additives and other inorganic compounds and organic compounds can be added within a range that does not deteriorate the coating property and desired effects. On adding the following-given additives and other inorganic compounds and organic compounds, addition of excess amount thereof deteriorates the coating performance so that it is preferable to adjust the total amount of additives and other inorganic compounds and organic compounds to about 70% by mass or less to the total coating amount of the insulation coating, and more preferably 50% by mass of less. The total amount thereof may be 30% by mass or less.

### Additive

Applicable additive includes known cross-linking agent, surface-active agent, rust-preventive agent, and lubricant. The adding amount of the additive is preferably adjusted to about 30% by mass or less to the total solid content of the coating.

### Other Inorganic Compound and Organic Compound

The insulation coating can contain other inorganic compounds and/or organic compounds at a desired level.

For example, other oxide (sol) can be added if the liquid stability is assured. Applicable oxide (sol) includes silica (sol), (silica or silica sol, same is applied in the following), silicate, alumina (sol), titania(sol), tin oxide (sol), cerium oxide (sol), antimony oxide (sol), tungsten oxide (sol), and molybdenum oxide (sol).

For the case of a specifically small blending ratio of polysiloxane, addition of inorganic compound is preferred to improve adhesion property, corrosion resistance, and anti-sticking property of annealed sheet.

The inorganic compound is added preferably by an amount of 70% by mass or less, more preferably 50% by mass or less, to the total solid content in the coating. The adding amount thereof may be 60% by mass or less, or 40% by mass or less. Preferably the adding amount thereof is 5% by mass or more, and more preferably 10% by mass or more.

Our steel sheets have good coating characteristics without adding chromium compound. Therefore, from the point of preventing environmental pollution caused by the manufacturing process and by the products, preferably the insulation coating substantially does not contain chromium. The allowable chromium amount as an impurity is preferably regulated to 0.1% by mass or less as CrO₃ to the total mass of solid content (total coating amount) in the insulation coating.

### Manufacturing Method

The following is the description about the method for manufacturing the electrical steel sheet having the insulation coating.

The preliminary treatment for the electrical steel sheet used as the starting material is not specifically limited. Non-preliminary treatment or preliminary treatment is applicable. Preferred preliminary treatment includes degreasing by alkali or the like, and pickling by hydrochloric acid, sulfuric acid, phosphoric acid, and the like.

On the steel sheet, there is applied a coating liquid which contains above-described polysiloxane and the polymer containing carbon. After that, baking treatment is applied to the electrical steel sheet applied with the above coating liquid, thus forming the insulation coating on the electrical steel sheet.

At this step, the coating liquid preferably has the blending ratio of polysiloxane within a range from 10 to 90% by mass as SiO₂ to the total solid content. As described above, the blending ratio thereof of less than 10% by mass results in reduced percentage of remained coating after the stress relieving annealing, which may deteriorate the anti-sticking property. When the blending ratio of polysiloxane increases, the coating becomes strong. If, however, the blending ratio thereof exceeds 90% by mass, flexibility becomes insufficient, and the corrosion resistance may deteriorate depending on the manufacturing conditions.

The three-dimensional network structure of the coating can be attained by the above treatment. To form further dense network structure and for further surely forming the network structure, however, it is preferable that the polysiloxane and the polymer containing carbon element are cross-linked with each other in advance in the coating liquid. Thus the three-dimensional network structure may be strengthened by further adding a cross-linking agent. It is also effective to use a polysiloxane containing functional group such as hydroxyl group and alkoxy group.

The raw material of the applying coating is preferably aqueous or oily material of paste or the liquid type. From the point not to increase unnecessarily the coating thickness (coating weight), however, the raw material thereof is preferably of the liquid type with the basis of water or organic solvent. In the following description, the term “coating liquid” also includes the paste type in principle.

Applicable methods for applying the insulation coating adopts varieties of apparatuses used generally in industry, such as roll coater, flow coater, spray, knife coater, and bar coater.

Also for the baking method, ordinarily applied ones can be used, such as hot air type, infrared heating type, and induction heating type. The baking temperature may be at an ordinary level. To avoid thermal decomposition of the resin, however, the baking temperature is preferably selected to 350° C. or below, and a more preferable range is 150° C. or above and 300° C. or below.

### Coating Weight of Insulation Coating

Although the coating weight of the insulation coating is not specifically limited, it is preferred to regulate the range from 0.05 g/m² or more to 10 g/m² of less per one coating side, and more preferably from 0.1 g/m² or more to 10 g/m² or less per one coating side. If the coating weight thereof is less than 0.05 g/m², it is industrially difficult to attain uniform application, and in some cases, stable punchability and corrosion resistance cannot be attained. If the coating weight thereof exceeds 10 g/m², further improvement of coating performance cannot be obtained, and economy may be lost. The measurement of coating weight is conducted on the steel sheet which completed baking treatment and does not receive stress relieving annealing, and the measurement can adopt the weight method in which only the coating is dissolved in hot-alkali or the like, and the weight change before and after dissolving is determined.

A preferred range of coating weight after the stress relieving annealing is from about 0.01 g/m² or more to about 9.0 g/m² or less.

The insulation coating is preferably formed on both sides of the steel sheet. Depending on the objective, however, the insulation coating may be formed only on one side thereof. That is, depending on the objective, the insulation coating is formed only on one side of the steel sheet, while the other side is coated by another insulation coating, of the other side is left non-coated.

The applications of the electrical steel sheet having the insulation coating are not specifically limited. To utilize the heat resistance of the coating, however, a most suitable application is to use the electrical steel sheet being subjected to stress relieving annealing at an approximate temperature range from 750° C. to 850° C.. For example, specifically suitable use is the manufacture of laminated iron cores by punching electrical steel sheets, and by applying stress relieving annealing to them, then by laminating them.

### EXAMPLE 1

Aspects of our steel sheets are described in detail referring to the examples. However, our steel sheets are not limited to these examples.

As the electrical steel sheet, there was adopted a fully processed electrical steel sheet which contained the steel components of 0.45% by mass Si, 0.25% by mass Mn, and 0.48% by mass Al, and which was treated by finish annealing haying a sheet thickness of 0.5 mm. The respective composite resins, which were cross-linked between polysiloxane and the respective resins in advance under the respective conditions given in Tables 1, 3, and 5, were applied on the electrical steel sheet, respectively, using roll coater. The coated steel sheets were baked in a hot-air furnace at a baking temperature of 230° C. as the peak metal temperature, thus prepared the respective specimens. For some of Examples and Comparative Examples, the chemicals given in Tables 1, 3, and 5 were added as the component other than the composite resin.

For thus prepared specimens (electrical steel sheets having insulation coating), the coating was dissolved in a boiling 50% NaOH aqueous solution, and the coating weight of the insulation coating was determined using the above-described weight method.

For thus obtained electrical steel sheets having insulation coating, the following-described coating characteristics were determined and evaluated.

### Corrosion Resistance—Product Sheet 1

To the specimens, humidity cabinet test (50° C., higher than 98% RH (relative humidity)) was given to evaluate the red rust generation rate after 48 hours by visual observation in terms of area percentage.

### Judgment Criterion

A: Red rust area percentage: from 0% to less than 20%
B: Red rust area percentage: from 20% to less than 40%
C: Red rust area percentage: from 40% to less than 60%
D: Red rust area percentage: from 60% to 100%

### Corrosion Resistance—Product Sheet 2

To the specimens, salt spray test (35° C.) specified by JIS Z 2371 was given to evaluate the red rust generation rate after 5 hours by visual observation in terms of area percentage.

Judgment Criterion
A: Red rust area percentage: from 0% to less than 25%
B: Red rust area percentage: from 25% to less than 50%
C: Red rust area percentage: from 50% to less than 75%
D: Red rust area percentage: from 75% to 100%

### Corrosion Resistance After the Stress Relieving Annealing (Corrosion Resistance—Annealed Sheet)

To the specimens, annealing was given in nitrogen atmosphere under a condition of 750° C. for 2 hours. To thus obtained annealed sheets, constant temperature and humidity test (50° C. and 80% RH) was given to evaluate the red rust generation rate after 14 days by visual observation in terms of area percentage.

Judgment Criterion
A: Red rust area percentage: from 0% to less than 20%
B: Red rust area percentage: from 20% to less than 40%
C: Red rust area percentage: from 40% to less than 60%
D: Red rust area percentage: from 60% to 100%

### Adhesion Property

To (i) the specimens and to (ii) the annealed sheets treated by annealing in nitrogen atmosphere under a condition of 750° C. for 2 hours, the bending and straightening test was given at 20 mmφ and 180°, thereby evaluated the adhesion property by visual observation in terms of coating peeling rate.

Judgment Criterion
A: No peeling occurred.
B: Peeling rate is less than 20%.
C: Peeling rate is 20% or more and less than 40%.
D: Peeling rate is 40% or more to entire area peeling.

### Solvent Resistance

Various kinds of solvents (hexane, xylene, methanol, and ethanol) were impregnated in absorbent cotton, respectively. Let each impregnated cotton rub back and forth by five times on the surface of each specimen. The change in appearance after that was visually observed.

Judgment Criterion
A: No change occurred.
B: Very little change occurred.
C: Slightly discolored.
D: Significant change occurred.

### Punchability

With a 15 mmφ steel die, the specimen was punched repeatedly until the bur height reached 50 μm. The, evaluation was given by the number of punch cycles at the 50 μm height.

Judgment Criterion
A: One million cycles or more
B: 500 thousand cycles or more and less than one million cycles
C: 100 thousand cycles or more and less than 500 thousand cycles
D: less than 100 thousand cycles

### Anti-Sticking Property

Ten sheets of specimens each having 50 mm square size were stacked. The stacked specimens were annealed while applying a load (200 g/cm²) in, nitrogen atmosphere under a condition of 750°C. for 2 hours. Then, a weight of 500 g was dropped onto the specimens (steel sheets), and the dropping height that induced breaking of the specimens into five segments was determined.

Judgment Criterion
A: 10 cm or less
B: more than 10 cm and not more than 15 cm
C: more than 15 cm and not more than 30 cm
D: more than 30 cm

Tables 2, 4, and 6 show the results of above tests.

TABLE 1

| | | | Component other than | | | |
|---|---|---|---|---|---|---|
| | Composite resin | | the composite resin | | | |
| | | Blending | | Blending | | |
| | | ratio of | | ratio of | Blending | |
| | | polysiloxane | | other | ratio of | |
| | | in the | | component | polysiloxane | |
| | | composite | | in the | in total solid | Coating |
| | | resin (%) | Kind of | coating | content (%) | weight |
| | Resin skeleton | (as SiO₂) | chemicals | (%) | (as SiO₂) | (g/m²) |
| Example 1 | Vinyl acetate | 50 | — | — | 50 | 0.3 |
| Example 2 | Acrylic | 50 | — | — | 50 | 0.9 |
| Example 3 | Polyester | 50 | — | — | 50 | 0.05 |
| Example 4 | Alkyd | 50 | — | — | 50 | 10 |
| Example 5 | Polyurethane | 90 | — | — | 90 | 1.2 |
| Example 6 | Acrylic | 10 | — | — | 10 | 2.5 |
| Example 7 | Acrylic | 75 | — | — | 75 | 0.8 |
| Example 8 | Acrylic | 25 | Silica | 30 | 17.5 | 0.8 |
| | | | sol(20 nm) | | | |
| Example 9 | Acrylic | 50 | — | — | 50 | 0.8 |
| Example 10 | Acrylic | 50 | — | — | 50 | 0.8 |
| Example 11 | Acrylic | 5 | — | — | 5 | 4.0 |
| Example 12 | Acrylic | 95 | — | — | 95 | 0.5 |
| Example 13 | Acrylic | 50 | — | — | 50 | 0.03 |
| Example 14 | Acrylic | 50 | — | — | 50 | 12 |
| Comparative | — | — | Silica | 50 | 0 | 0.8 |
| Example 1 | | | sol(20 nm) | | | |
| | | | Acrylic resin | 50 | | |
| Comparative | — | — | Acrylic resin | 100 | 0 | 0.8 |
| Example 2 | | | | | | |
| Example 15 | Acrylic | 10 | — | — | 10 | 0.8 |
| Example 16 | Vinyl acetate | 10 | — | — | 10 | 0.8 |
| Example 17 | Polyester | 10 | — | — | 10 | 0.8 |
| Example 18 | Alkyd | 10 | — | — | 10 | 0.8 |
| Example 19 | Polyurethane | 10 | — | — | 10 | 0.8 |
| Example 20 | Polystyrene | 10 | — | — | 10 | 0.8 |
| Example 21 | Polyethylene | 10 | — | — | 10 | 0.8 |
| Example 22 | Polypropylene | 10 | — | — | 10 | 0.8 |
| Example 23 | Polyamide | 10 | — | — | 10 | 0.8 |
| Example 24 | Polycarbonate | 10 | — | — | 10 | 0.8 |
| Example 25 | Phenol | 10 | — | — | 10 | 0.8 |
| Example 26 | Epoxy | 10 | — | — | 10 | 0.8 |
| Example 27 | Polyurethane | 50 | — | — | 50 | 0.8 |
| Example 28 | Polystyrene | 50 | — | — | 50 | 0.8 |
| Example 29 | Polyethylene | 50 | — | — | 50 | 0.8 |
| Example 30 | Polypropylene | 50 | — | — | 50 | 0.8 |
| Example 31 | Polyamide | 50 | — | — | 50 | 0.8 |
| Example 32 | Polycarbonate | 50 | — | — | 50 | 0.8 |
| Example 33 | Phenol | 50 | — | — | 50 | 0.8 |
| Example 34 | Epoxy | 50 | — | — | 50 | 0.8 |

TABLE 2

| | Corrosion | | | Adhesion | | | | | | | | |
|---|---|---|---|---|---|---|---|---|---|---|---|---|
| | resistance | | | property | | | | | | | Anti- | |
| | Product | Product | Annealed | Product | Annealed | Solvent resistance | | | | | sticking | |
| | sheet 1 | sheet 2 | sheet | sheet | sheet | Hexane | Xylene | Methanol | Ethanol | Punchability | property | Remarks |
| Example 1 | A | B | A | A | A | A | A | B | B | A | B | |
| Example 2 | A | A | A | A | A | A | A | A | A | A | A | |
| Example 3 | B | B | A | A | A | A | A | A | A | A | B | |
| Example 4 | A | A | A | B | B | A | A | A | A | A | A | |
| Example 5 | A | A | A | A | A | A | A | A | A | B | A | |
| Example 6 | A | A | B | A | B | A | B | B | B | A | B | |
| Example 7 | A | A | A | A | A | A | A | A | A | A | A | |
| Example 8 | B | B | A | A | A | A | A | A | A | B | A | |
| Example 9 | A | A | A | A | A | A | A | A | A | A | A | |
| Example 10 | A | A | A | A | A | A | A | A | A | A | A | |
| Example 11 | A | A | C | B | C | A | C | C | C | A | C | Blending ratio |
| | | | | | | | | | | | | of polysiloxane |
| | | | | | | | | | | | | is outside the |
| | | | | | | | | | | | | preferred range. |
| Example 12 | A | A | A | A | A | A | A | A | A | C | A | ditto |
| Example 13 | C | C | C | A | A | A | A | A | A | A | C | Coating weight |
| | | | | | | | | | | | | is outside the |
| | | | | | | | | | | | | preferred range. |
| Example 14 | A | A | A | C | C | A | A | A | A | A | A | ditto |
| Comparative | D | D | A | A | A | A | A | A | A | D | A | |
| Example 1 | | | | | | | | | | | | |
| Comparative | B | B | D | A | D | A | D | D | D | A | D | |
| Example 2 | | | | | | | | | | | | |
| Example 15 | A | A | B | A | B | A | B | B | B | A | B | |
| Example 16 | A | A | B | A | B | A | B | B | B | A | B | |
| Example 17 | A | A | B | A | B | A | B | B | B | A | B | |
| Example 18 | A | A | B | A | B | A | B | B | B | A | B | |
| Example 19 | A | A | B | A | B | A | B | B | B | A | B | |
| Example 20 | A | A | B | A | B | A | B | B | B | A | B | |
| Example 21 | A | A | B | A | B | A | B | B | B | A | B | |
| Example 22 | A | A | B | A | B | A | B | B | B | A | B | |
| Example 23 | A | A | B | A | B | A | B | B | B | A | B | |
| Example 24 | A | A | B | A | B | A | B | B | B | A | B | |
| Example 25 | A | A | B | A | B | A | B | B | B | A | B | |
| Example 26 | A | A | B | A | B | A | B | B | B | A | B | |
| Example 27 | A | A | A | A | A | A | A | A | A | A | A | |
| Example 28 | A | A | A | A | A | A | A | A | A | A | A | |
| Example 29 | A | A | A | A | A | A | A | A | A | A | A | |
| Example 30 | A | A | A | A | A | A | A | A | A | A | A | |
| Example 31 | A | A | A | A | A | A | A | A | A | A | A | |
| Example 32 | A | A | A | A | A | A | A | A | A | A | A | |
| Example 33 | A | A | A | A | A | A | A | A | A | A | A | |
| Example 34 | A | A | A | A | A | A | A | A | A | A | A | |

TABLE 3

| | | | Component other than | | | |
|---|---|---|---|---|---|---|
| | Composite resin | | the composite resin | | | |
| | | Blending | | Blending | | |
| | | ratio of | | ratio | Blending | |
| | | polysiloxane | | of | ratio of | |
| | | in the | | other | polysiloxane | |
| | | composite | | component | in total solid | Coating |
| | | resin (%) | Kind of | in the | content (%) | weight |
| | Resin skeleton | (as SiO₂) | chemicals | coating (%) | (as SiO₂) | (g/m²) |
| Example 35 | Vinyl acetate | 75 | — | — | 75 | 0.8 |
| Example 36 | Polyester | 75 | — | — | 75 | 0.8 |
| Example 37 | Alkyd | 75 | — | — | 75 | 0.8 |
| Example 38 | Polyurethane | 75 | — | — | 75 | 0.8 |
| Example 39 | Polystyrene | 75 | — | — | 75 | 0.8 |
| Example 40 | Polyethylene | 75 | — | — | 75 | 0.8 |
| Example 41 | Polypropylene | 75 | — | — | 75 | 0.8 |
| Example 42 | Polyamide | 75 | — | — | 75 | 0.8 |
| Example 43 | Polycarbonate | 75 | — | — | 75 | 0.8 |
| Example 44 | Phenol | 75 | — | — | 75 | 0.8 |
| Example 45 | Epoxy | 75 | — | — | 75 | 0.8 |
| Example 46 | Vinyl acetate | 90 | — | — | 90 | 0.8 |
| Example 47 | Acrylic | 90 | — | — | 90 | 0.8 |
| Example 48 | Polyester | 90 | — | — | 90 | 0.8 |
| Example 49 | Alkyd | 90 | — | — | 90 | 0.8 |
| Example 50 | Polyurethane | 90 | — | — | 90 | 0.8 |
| Example 51 | Polystyrene | 90 | — | — | 90 | 0.8 |
| Example 52 | Polyethylene | 90 | — | — | 90 | 0.8 |
| Example 53 | Polypropylene | 90 | — | — | 90 | 0.8 |
| Example 54 | Polyamide | 90 | — | — | 90 | 0.8 |
| Example 55 | Polycarbonate | 90 | — | — | 90 | 0.8 |
| Example 56 | Phenol | 90 | — | — | 90 | 0.8 |
| Example 57 | Epoxy | 90 | — | — | 90 | 0.8 |
| Example 58 | Acrylic | 6 | Silica | 20 | 4.8 | 0.8 |
| | | | sol(20 nm) | | | |
| Example 59 | Acrylic | 12 | Silica | 20 | 9.6 | 0.8 |
| | | | sol(20 nm) | | | |
| Example 60 | Acrylic | 50 | Silica | 30 | 35 | 0.8 |
| | | | sol(20 nm) | | | |
| Example 61 | Acrylic | 50 | Silica | 50 | 25 | 0.8 |
| | | | sol(20 nm) | | | |
| Example 62 | Acrylic | 50 | Silica | 30 | 35 | 0:8 |
| | | | sol(10 nm) | | | |
| Example 63 | Acrylic | 50 | Na silicate | 39 | 35 | 0.8 |
| Example 64 | Acrylic | 50 | K silicate | 30 | 35 | 0.8 |
| Example 65 | Acrylic | 50 | Li silicate | 30 | 35 | 0.8 |
| Example 66 | Acrylic | 50 | Alumina | 30 | 35 | 0.8 |
| | | | sol | | | |
| Example 67 | Acrylic | 50 | Titania sol | 30 | 35 | 0.8 |
| Example 68 | Acrylic | 50 | Tin sol | 30 | 35 | 0.8 |

TABLE 4

| | Corrosion | | | Adhesion | | | | | | | | |
|---|---|---|---|---|---|---|---|---|---|---|---|---|
| | resistance | | | property | | | | | | | Anti- | |
| | Product | Product | Annealed | Product | Annealed | Solvent resistance | | | | | sticking | |
| | sheet 1 | sheet 2 | sheet | sheet | sheet | Hexane | Xylene | Methanol | Ethanol | Punchability | property | Remarks |
| Example 35 | A | A | A | A | A | A | A | A | A | A | A | |
| Example 36 | A | A | A | A | A | A | A | A | A | A | A | |
| Example 37 | A | A | A | A | A | A | A | A | A | A | A | |
| Example 38 | A | A | A | A | A | A | A | A | A | A | A | |
| Example 39 | A | A | A | A | A | A | A | A | A | A | A | |
| Example 40 | A | A | A | A | A | A | A | A | A | A | A | |
| Example 41 | A | A | A | A | A | A | A | A | A | A | A | |
| Example 42 | A | A | A | A | A | A | A | A | A | A | A | |
| Example 43 | A | A | A | A | A | A | A | A | A | A | A | |
| Example 44 | A | A | A | A | A | A | A | A | A | A | A | |
| Example 45 | A | A | A | A | A | A | A | A | A | A | A | |
| Example 46 | A | A | A | A | A | A | A | A | A | B | A | |
| Example 47 | A | A | A | A | A | A | A | A | A | B | A | |
| Example 48 | A | A | A | A | A | A | A | A | A | B | A | |
| Example 49 | A | A | A | A | A | A | A | A | A | B | A | |
| Example 50 | A | A | A | A | A | A | A | A | A | B | A | |
| Example 51 | A | A | A | A | A | A | A | A | A | B | A | |
| Example 52 | A | A | A | A | A | A | A | A | A | B | A | |
| Example 53 | A | A | A | A | A | A | A | A | A | B | A | |
| Example 54 | A | A | A | A | A | A | A | A | A | B | A | |
| Example 55 | A | A | A | A | A | A | A | A | A | B | A | |
| Example 56 | A | A | A | A | A | A | A | A | A | B | A | |
| Example 57 | A | A | A | A | A | A | A | A | A | B | A | |
| Example 58 | A | A | B | A | B | A | A | A | A | A | B | Corresponding |
| | | | | | | | | | | | | to Example 11 |
| | | | | | | | | | | | | (smaller |
| | | | | | | | | | | | | blending ratio of |
| | | | | | | | | | | | | polysiloxane) + |
| | | | | | | | | | | | | inorganic |
| | | | | | | | | | | | | compound |
| Example 59 | A | A | A | A | A | A | A | A | A | A | A | Corresponding |
| | | | | | | | | | | | | to Example 15 |
| | | | | | | | | | | | | (smaller |
| | | | | | | | | | | | | blending ratio |
| | | | | | | | | | | | | of |
| | | | | | | | | | | | | polysiloxane) + |
| | | | | | | | | | | | | inorganic |
| | | | | | | | | | | | | compound |
| Example 60 | B | B | A | A | A | A | A | A | A | A | A | |
| Example 61 | B | B | B | A | B | A | A | A | A | A | A | |
| Example 62 | B | B | A | A | A | A | A | A | A | A | A | |
| Example 63 | B | B | A | A | A | A | A | A | A | A | A | |
| Example 64 | B | B | A | A | A | A | A | A | A | A | A | |
| Example 65 | B | B | A | A | A | A | A | A | A | A | A | |
| Example 66 | B | B | A | A | A | A | A | A | A | A | A | |
| Example 67 | B | B | A | A | A | A | A | A | A | A | A | |
| Example 68 | B | B | A | A | A | A | A | A | A | A | A | |

TABLE 5

| | | | Component other than | | | |
|---|---|---|---|---|---|---|
| | Composite resin | | the composite resin | | | |
| | | Blending | | Blending | | |
| | | ratio of | | ratio | Blending | |
| | | polysiloxane | | of | ratio of | |
| | | in the | | other | polysiloxane | |
| | | composite | | component | in total solid | Coating |
| | Resin | resin (%) | Kind of | in the | content (%) | weight |
| | skeleton | (as SiO₂) | chemicals | coating (%) | (as SiO₂) | (g/m²) |
| Example 69 | Acrylic | 50 | Cerium sol | 30 | 35 | 0.8 |
| Example 70 | Acrylic | 50 | Antimony sol | 30 | 35 | 0.8 |
| Example 71 | Acrylic | 50 | Tungsten sol | 30 | 35 | 0.8 |
| Example 72 | Acrylic | 50 | Molybdenum | 30 | 35 | 0.8 |
| | | | sol | | | |
| Example 73 | Acrylic | 75 | Silica | 30 | 52.5 | 0.8 |
| | | | sol(20 nm) | | | |
| Example 74 | Acrylic | 75 | Silica | 50 | 37.5 | 0.8 |
| | | | sol(20 nm) | | | |
| Example 75 | Acrylic | 75 | Silica | 50 | 37.5 | 0.8 |
| | | | sol(10 nm) | | | |
| Example 76 | Acrylic | 75 | Na silicate | 30 | 52.5 | 0.8 |
| Example 77 | Acrylic | 75 | K silicate | 30 | 52.5 | 0.8 |
| Example 78 | Acrylic | 75 | Li silicate | 30 | 52.5 | 0.8 |
| Example 79 | Acrylic | 75 | Alumina sol | 30 | 52.5 | 0.8 |
| Example 80 | Acrylic | 75 | Titania sol | 30 | 52.5 | 0.8 |
| Example 81 | Acrylic | 75 | Tin sol | 30 | 52.5 | 0.8 |
| Example 82 | Acrylic | 75 | Cerium sol | 30 | 52.5 | 0.8 |
| Example 83 | Acrylic | 75 | Antimony sol | 30 | 52.5 | 0.8 |
| Example 84 | Acrylic | 75 | Tungsten sol | 30 | 52.5 | 0.8 |
| Example 85 | Acrylic | 75 | Molybdenum | 30 | 52.5 | 0.8 |
| | | | sol | | | |
| Example 86 | Acrylic | 90 | Silica | 30 | 63 | 0.8 |
| | | | sol(20 nm) | | | |
| Example 87 | Acrylic | 90 | Silica | 50 | 45 | 0.8 |
| | | | sol(20 nm) | | | |
| Example 88 | Acrylic | 90 | Silica | 50 | 45 | 0.8 |
| | | | sol(10 nm) | | | |
| Example 89 | Acrylic | 90 | Na silicate | 30 | 63 | 0.8 |
| Example 90 | Acrylic | 90 | K silicate | 30 | 63 | 0.8 |
| Example 91 | Acrylic | 90 | Li silicate | 30 | 63 | 0.8 |
| Example 92 | Acrylic | 90 | Alumina sol | 30 | 63 | 0.8 |
| Example 93 | Acrylic | 90 | Titania sol | 30 | 63 | 0.8 |
| Example 94 | Acrylic | 90 | Tin sol | 30 | 63 | 0.8 |
| Example 95 | Acrylic | 90 | Cerium sol | 30 | 63 | 0.8 |
| Example 96 | Acrylic | 90 | Antimony sol | 30 | 63 | 0.8 |
| Example 97 | Acrylic | 90 | Tungsten sol | 30 | 63 | 0.8 |
| Example 98 | Acrylic | 90 | Molybdenum | 30 | 63 | 0.8 |
| | | | sol | | | |
| Example 99 | Acrylic- | 75 | — | — | 75 | 0.8 |
| | styrene* | | | | | |
| Example 100 | Acrylic- | 75 | Silica | 30 | 52.5 | 0.8 |
| | styrene* | | sol(20 nm) | | | |
| Example 101 | Acrylic- | 75 | — | — | 75 | 0.8 |
| | ethylene* | | | | | |
| Example 102 | Acrylic | 50 | Silica | 60 | 20 | 0.8 |
| | | | sol(20 nm) | | | |
| Example 103 | Acrylic | 50 | Silica | 70 | 15 | 0.8 |
| | | | sol(20 nm) | | | |

| | | |
|---|---|---|
| Reference | 85 parts by weight of magnesium chromate and 15 parts | 0.8 |
| Example | by weight of acrylic resin. | |

*Copolymer of both resins.

TABLE 6

| | Corrosion | | | Adhesion | | | | | | | | |
|---|---|---|---|---|---|---|---|---|---|---|---|---|
| | resistance | | | property | | | | | | | | |
| | Product | Product | Annealed | Product | Annealed | Solvent resistance | | | | | Anti-sticking | |
| | sheet 1 | sheet 2 | sheet | sheet | sheet | Hexane | Xylene | Methanol | Ethanol | Punchability | property | Remarks |
| Example 69 | B | B | A | A | A | A | A | A | A | A | A | |
| Example 70 | B | B | A | A | A | A | A | A | A | A | A | |
| Example 71 | B | B | A | A | A | A | A | A | A | A | A | |
| Example 72 | B | B | A | A | A | A | A | A | A | A | A | |
| Example 73 | B | B | A | A | A | A | A | A | A | B | A | |
| Example 74 | B | B | B | A | B | A | A | A | A | B | A | |
| Example 75 | B | B | B | A | B | A | A | A | A | B | A | |
| Example 76 | B | B | A | A | A | A | A | A | A | A | A | |
| Example 77 | B | B | A | A | A | A | A | A | A | A | A | |
| Example 78 | B | B | A | A | A | A | A | A | A | A | A | |
| Example 79 | B | B | A | A | A | A | A | A | A | A | A | |
| Example 80 | B | B | A | A | A | A | A | A | A | A | A | |
| Example 81 | B | B | A | A | A | A | A | A | A | A | A | |
| Example 82 | B | B | A | A | A | A | A | A | A | A | A | |
| Example 83 | B | B | A | A | A | A | A | A | A | A | A | |
| Example 84 | B | B | A | A | A | A | A | A | A | A | A | |
| Example 85 | B | B | A | A | A | A | A | A | A | A | A | |
| Example 86 | B | B | A | A | A | A | A | A | A | B | A | |
| Example 87 | B | B | B | A | B | A | A | A | A | B | A | |
| Example 88 | B | B | B | A | B | A | A | A | A | B | A | |
| Example 89 | B | B | A | A | A | A | A | A | A | A | A | |
| Example 90 | B | B | A | A | A | A | A | A | A | A | A | |
| Example 91 | B | B | A | A | A | A | A | A | A | A | A | |
| Example 92 | B | B | A | A | A | A | A | A | A | A | A | |
| Example 93 | B | B | A | A | A | A | A | A | A | A | A | |
| Example 94 | B | B | A | A | A | A | A | A | A | A | A | |
| Example 95 | B | B | A | A | A | A | A | A | A | A | A | |
| Example 96 | B | B | A | A | A | A | A | A | A | A | A | |
| Example 97 | B | B | A | A | A | A | A | A | A | A | A | |
| Example 98 | B | B | A | A | A | A | A | A | A | A | A | |
| Example 99 | A | A | A | A | A | A | A | A | A | A | A | |
| Example 100 | B | B | A | A | A | A | A | A | A | B | A | |
| Example 101 | A | A | A | A | A | A | A | A | A | A | A | |
| Example 102 | B | B | B | A | B | A | A | A | A | B | A | |
| Example 103 | B | B | B | A | B | A | A | A | A | B | A | |
| Reference | A | A | B | A | B | A | A | A | A | A | A | |
| Example | | | | | | | | | | | | |

As seen in Tables 1 to 6, our Examples gave excellent corrosion resistance, adhesion property, solvent resistance, punchability, and anti-sticking property. In particular, our Examples having preferable range of polysiloxane blending ratio and coating weight of insulation coating further improved the above characteristics. For the case of small blending ratio of polysiloxane, particularly the addition of an inorganic compound improved various characteristics.

To the contrary, the Comparative Examples deteriorated one or more of corrosion resistance, adhesion property, solvent resistance, punchability, and anti-sticking property.

### INDUSTRIAL APPLICABILITY

We provide electrical steel sheets having an insulation coating giving excellent corrosion resistance and punchability. The electrical steel sheets having the insulation coating do not contain chromium, and give performances such as corrosion resistance and punchability equivalent to or higher than those of Cr-containing insulation coating. Consequently, our steel sheets are friendly to the environment not only as the final products, but also during the manufacturing process, and allows wide use including motors and transformers.

1-12. (canceled)

13. An electrical steel sheet having an insulation coating, wherein the insulation coating contains a composite resin composed of polysiloxane and a polymer containing carbon.

14. The electrical steel sheet according to claim 13, wherein the blending ratio of the polysiloxane to the solid content in the insulation coating is 10% by mass or more and 90% by mass or less as SiO₂.

15. The electrical steel sheet according to claim 13, wherein the polymer containing carbon is at least one polymer selected from the group consisting of vinyl-based polymer, polyester-based polymer, alkyd-based polymer, polyurethane-based polymer, acrylic-based polymer, styrene-based polymer, polyethylene-based polymer, polypropylene-based polymer, polyamide-based polymer, polycarbonate-based polymer, phenol-based polymer, and epoxy-based polymer.

16. The electrical steel sheet according to claim 14, wherein the polymer containing carbon is at least one polymer selected from the group consisting of vinyl-based polymer, polyester-based polymer, alkyd-based polymer, polyurethane-based polymer, acrylic-based polymer, styrene-based polymer, polyethylene-based polymer, polypropylene-based polymer, polyamide-based polymer, polycarbonate-based polymer, phenol-based polymer, and epoxy-based polymer.

17. The electrical steel sheet according to claim 13, wherein the insulation coating further contains at least one compound selected from the group consisting of silica, silicate, alumina, titania, tin oxide, cerium oxide, antimony oxide, tungsten oxide, and molybdenum oxide, as the inorganic compound.

18. The electrical steel sheet according to claim 14, wherein the insulation coating further contains at least one compound selected from the group consisting of silica, silicate, alumina, titania, tin oxide, cerium oxide, antimony oxide, tungsten oxide, and molybdenum oxide, as the inorganic compound.

19. The electrical steel sheet according to claim 15, wherein the insulation coating further contains at least one compound selected from the group consisting of silica, silicate, alumina, titania, tin oxide, cerium oxide, antimony oxide, tungsten oxide, and molybdenum oxide, as the inorganic compound.

20. The electrical steel sheet according to claim 16, wherein the insulation coating further contains at least one compound selected from the group consisting of silica, silicate, alumina, titania, tin oxide, cerium oxide, antimony oxide, tungsten oxide, and molybdenum oxide, as the inorganic compound.

21. The electrical steel sheet according to claim 13, wherein the coating weight of the insulation coating is 0.05 g/m² or more and 10 g/m² or less.

22. The electrical steel sheet according to claim 14, wherein the coating weight of the insulation coating is 0.05 g/m² or more and 10 g/m² or less.

23. A method for manufacturing an electrical steel sheet having an insulation coating, comprising: applying a coating liquid containing polysiloxane and a polymer containing carbon on a surface of an electrical steel sheet; and baking the electrical steel sheet with the coating liquid applied on the electrical steel sheet.

24. The method according to claim 23, wherein the polymer containing carbon contains at least one polymer selected from the group consisting of vinyl-based polymer, polyester-based polymer, alkyd-based polymer, polyurethane-based polymer, acrylic-based polymer, styrene-based polymer, polyethylene-based polymer, polypropylene-based polymer, polyamide-based polymer, polycarbonate-based polymer, phenol-based polymer, and epoxy-based polymer.

25. The method according to claim 23, wherein the coating liquid further contains at least one compound selected from the group consisting of silica, silicate, alumina, titania, tin oxide, cerium oxide, antimony oxide, tungsten oxide, and molybdenum oxide, as the inorganic compound.

26. The method according to claim 23, wherein the coating liquid further contains at least one compound selected from the group consisting of silica, silicate, alumina, titania, tin oxide, cerium oxide, antimony oxide, tungsten oxide, and molybdenum oxide, as the inorganic compound.

27. The method according to claim 23, wherein the blending ratio of the polysiloxane to the total solid content in the coating liquid is 10% by mass or more and 90% by mass or less as SiO₂.

28. The method according to claim 24, wherein the blending ratio of the polysiloxane to the total solid content in the coating liquid is 10% by mass or more and 90% by mass or less as SiO₂.

29. The method according to claim 25, wherein the blending ratio of the polysiloxane to the total solid content in the coating liquid is 10% by mass or more and 90% by mass or less as SiO₂.

30. The method according to claim 23, wherein the insulation coating is prepared by applying a coating liquid on the surface of an electrical steel sheet and baking so that the coating weight of the insulation coating is 0.05 g/m² or more and 10 g/m² or less.

31. The method according to claim 24, wherein the insulation coating is prepared by applying a coating liquid on the surface of an electrical steel sheet and baking so that the coating weight of the insulation coating is 0.05 g/m² or more and 10 g/m² or less.
